(19) United States
(12) Patent Application Publication
(10) Pub. No.: US 2026/0101901 A1
(43) Pub. Date: Apr. 16, 2026

(54) DELAYING BLOOM IN HORTICULTURAL CROPS USING JASMONIC ACID BIOSYNTHESIS INHIBITORS

(71) Applicant: VIRGINIA TECH INTELLECTUAL PROPERTIES INC., Blacksburg, VA (US)

(72) Inventors: Sherif M. Sherif, Stephens City, VA (US); Jianyang LIU, Winchester, VA (US); Md Tabibul ISLAM, Winchester, VA (US)

(21) Appl. No.: 19/114,091

(22) PCT Filed: Sep. 25, 2023
(86) PCT No.: PCT/US2023/075032

§ 371 Date: Mar. 21, 2025

Related U.S. Application Data
(60) Provisional application No. 63/377,083, filed on Sep. 26, 2022.

(51) Int. Cl. A01N 47/14; A01N 37/10; A01N 37/28; A01N 43/16; A01N 43/50; A01P 21/00

(52) U.S. Cl. CPC A01N 47/14; A01N 37/10; A01N 37/28; A01N 43/16; A01N 43/50; A01P 21/00

(57) ABSTRACT

Peach production in temperate regions is often threatened by spring frost during late winter or early spring. Currently, effective methods to mitigate frost damage are largely lacking. Plant growth regulators (PGR) to enhance cold hardiness or to delay budburst and bloom date until the risk of frost damage has passed or diminished are considered to hold high potential in ameliorating frost damage due to their high efficiency, relatively low cost, and ease of implementation. However, proper PGRs that can delay bloom effectively and safely are yet to be identified. Disclosed herein is a method for delaying flowering of deciduous fruit trees that involves applying to the tree an effective amount of a jasmonate inhibitor, such as diethyldithiocarbamate (DIECA).

### CROSS-REFERENCE TO RELATED APPLICATIONS

This application claims benefit of U.S. Provisional Application No. 63/377,083, filed Sep. 26, 2022, which is hereby incorporated herein by reference in its entirety.

### BACKGROUND

Peach production in temperate regions is often threatened by spring frost during late winter or early spring. Spring frosts are the freezing events that occur after the plants have exited dormancy; the stage during which deciduous perennials are acclimated to the cold temperatures and is characterized by growth arrest (Lang, G. A. HortScience 1987 22:817-820). Three forms of bud dormancy exist in deciduous perennial trees including paradormancy, endodormancy and ecodormancy (Lang, G. A. HortScience 1987 22:817-820). The example of paradormancy is the apical dominance where the terminal bud imposes growth inhibition on lateral buds. In peach, this type of dormancy occurs early in the summer after terminal bud set. Unlike paradormancy, endodormancy involves mechanisms intrinsic to the bud itself and buds remain dormant despite the removal of terminal buds or defoliation. Ecodormancy, on the other hand, is imposed by environmental factors such as cold and drought, which trigger signals and pathways that prevent bud growth. The transition from endodormancy to ecodormancy is dependent on achieving chilling requirements (CR). CR is the minimum number of hours between 0-7.2° C., known as chilling hours (CH) that trees must receive during winter to overcome endodormancy. This trait is genotype-dependent and highly diverse across species and varieties. Some peach varieties require as high as 1000 CH and others require only 50 CH (Layne D., et al. Experimental Agriculture 2008 45:379-380). During ecodormancy, buds need a period of warm temperatures in the range of 4.5-25° C., known as heat requirements (HR) to initiate the subsequent developmental phases of budburst and flowering. HR, often expressed as growing degree hours (GDHs), is also a genotype-dependent trait (Layne D., et al. Experimental Agriculture 2008 45:379-380). After the trees release from dormancy, the newly developed tissues, such as buds, flowers and fruitlets become highly sensitive to low temperatures, and can be severely damaged or even killed in a single frost event. In North America and Europe, spring frost causes economic losses in fruit production more than any other climate-related hazards. Spring frost has always been a great challenge to temperate fruits, especially those grown in the Northeastern US. However, recent studies have also indicated that the phenology of dormancy and flowering in several woody perennials has advanced in recent decades due to global climate warming, increasing the frequency of devastating spring freezes (Unterberger, C., et al. Plos One 2018 13:7; Ma, Q., et al. Glob. Chang Biol. 2019 25:351-360).

Currently, effective methods to mitigate frost damage are largely lacking. The existing protection approaches can be characterized as active or passive. Active approaches are employed at the time of frosts, aiming to prevent or reduce the loss of thermal energy from plant tissues using tools such as helicopters, wind machines, sprinklers, and heaters, etc. These methods are generally labor-intensive, cost-inefficient, environmentally unsustainable, and their success heavily relies on the environmental conditions. In contrast, passive protections are intended to avoid frost with preemptive measures, such as adoption of cold-hardy or late-bloom varieties, selection of proper plantation site, or application of plant growth regulators (PGR) to enhance cold hardiness or to delay budburst and bloom date until the risk of frost damage has passed or diminished (Liu, J., et al. Front Plant Sci. 2019 10:1408). In particular, the use of PGR is considered to hold high potential in ameliorating frost damage due to its high efficiency, relatively low cost, and ease of implementation. However, proper PGRs that can delay bloom effectively and safely are yet to be identified.

### SUMMARY

Disclosed herein is a method for delaying flowering of deciduous fruit trees that involves applying to the tree an effective amount of a jasmonate inhibitor. In some embodiments, the jasmonate inhibitor is diethyldithiocarbamate (DIECA) or salt thereof. For example, in some embodiments, the jasmonate inhibitor comprises potassium-DIECA, sodium-DIECA, silver-DIECA, zinc-DIECA, or copper-DIECA. In some embodiments, the jasmonate inhibitor is JM-8686 or salt thereof. In some embodiments, the jasmonate inhibitor is neomycin. In some embodiments, the jasmonate inhibitor is an octadecanoid pathway inhibitor, such as n-propyl gallate, acetylsalicylic acid, salicylhydroxamic acid, or methyl salicylate and antipyrine.

In some embodiments, the deciduous fruit tree is any deciduous fruit tree that undergoes dormancy during winter. In some embodiments, the deciduous fruit tree is a pome fruit tree (apple, European pear, Asian peach, quince), stone fruit tree (peach, nectarine, apricot, sour cherry, sweet cherry, plum), or nut crop tree (pecan, walnut, almond, pistachio, hazel and filbert).

In some embodiments, the jasmonate inhibitor is administered at a concentration of 1 mM to 1000 mM, such as about 50 to 500 mM, e.g. 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 mM.

In some embodiments, the jasmonate inhibitor is applied at 100 to 3000 growing degree hours (GDH), including 100 to 500, e.g. 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500.

In some embodiments, the jasmonate inhibitor is applied to the tree prior to freezing conditions to delay flowering and prevent frost damage.

In some embodiments, flowering is delayed 3 to 28 days, such as 7 to 14 days, e.g. 3, 4, 5, 6, 7, 8, 9, 10, 11, 12, 13, 14, 15, 16, 17, 18, 19, 20, 21, 22, 23, 24, 25, 26, 27 or 28 days.

In some embodiments, the jasmonate inhibitor is applied to the tree when the temperature is below 32° F. or is forecast to drop below 32° F., e.g. within the next 3 to 28 days, such as 7 to 14 days, e.g. 3, 4, 5, 6, 7, 8, 9, 10, 11, 12, 13, 14, 15, 16, 17, 18, 19, 20, 21, 22, 23, 24, 25, 26, 27 or 28 days.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B show the effects of different concentrations of diethyldithiocarbamate (DIECA) application at 1000 GDH on the flowering time of ‘John Boy’ peach trees. Comparison of blooming between the untreated control and DIECA treatments (FIG. 1A) with photos taken at 50% open bloom of the controls. Blooming progression (FIG. 1B) is affected by DIECA, and the blooming rate is calculated as the ratio of the number of flowers to the number of buds on tagged branches.

FIGS. 2A and 2B show diethyldithiocarbamate (DIECA) effects on fruit set and fruit size of ‘John Boy’ peach trees. FIG. 2A shows fruit set (%) evaluated 3 and 6 WAFB. FIG. 2 B shows fruit size (mm) measured at 6 WAFB. WAFB, weeks after full bloom.

FIG. 3 shows bloom-delaying effects of different timing applications of diethyldithiocarbamate (DIECA) on ‘Redhaven’ peach trees. The blooming rate was calculated as the ratio of the number of flowers to the number of buds on tagged branches. GDH, growing degree hours.

FIGS. 4A to 4B show bloom-delaying effects of different concentrations of diethyldithiocarbamate (DIECA) at 500 GDH on ‘Redhaven’ peach trees. Comparison of blooming between the untreated control and DIECA treatments (FIG. 4A) with photos taken at 50% open bloom of the control. Blooming progression (FIG. 4B) is affected by DIECA, and the blooming rate is calculated as the ratio of the number of flowers to the number of buds on tagged branches.

FIG. 5 shows effects of different concentrations of diethyldithiocarbamate (DIECA) application at 500 GDH on fruit set (%) of ‘Redhaven’ peach trees. Fruit set (%) was evaluated 2 and 4 weeks after full bloom (WAFB).

FIGS. 6A and 6B show the effects of different concentrations of diethyldithiocarbamate (DIECA) applications at 2000 GDH on the flowering time of ‘John Boy’ peach trees. Comparison of blooming between the untreated control and DIECA treatments (FIG. 6A) with photos taken at 50% open bloom of the controls. Blooming progression (FIG. 6B) is affected by DIECA, and the blooming rate is calculated as the ratio of the number of flowers to the number of buds on tagged branches.

FIG. 7 shows effects of diethyldithiocarbamate (DIECA) exogenous application at 2000 GDH on the fruit set (%) of ‘John Boy’ peach trees. Fruit set (%) was evaluated 2 and 4 weeks after full bloom (WAFB).

FIG. 8 shows bloom-delaying effects of different of antipyrine and propyl gallate on (A) ‘Redhaven’, and (B) ‘Sunhigh’ peach. Blooming rate is calculated as the ratio of the number of flowers to the number of buds on tagged branches.

FIG. 9. Shows the effects of antipyrine and propyl gallate on fruit set (%) of ‘Redhaven’ peach. Fruit set (%) was evaluated 2, 4, and 8 weeks after full bloom (WAFB).

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biology, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

### Definitions

It must be noted that, as used in the specification and the appended claims, the singular forms “a,” “an,” and “the” include plural referents unless the context clearly dictates otherwise.

The term “administer” or “apply” as used herein refers to various ways in which a crop plant receives the compositions described herein (e.g., nutritional supplements, fertilizers, plant growth regulators, and combinations thereof). Methods of administration include, but are not limited to foliar spray, irrigation, soil application, soil injection, trunk injection (including branch injection), and trunk paints (including branch paints). Foliar spraying, a technique of feeding plants, involves directly applying the composition in liquid form to the canopy of the plant. Whereas leaves are typically the target of such applications, alternatively buds, inflorescences, flowers, and fruit might be the target of foliar sprays alone or in addition to leaves. In contrast, irrigation involves directly administering the composition to the root zone for uptake by the plant roots. Trunk injection involves directly administering the composition to the plant trunk or branch. As known in the art, trunk injection is a way to treat many different insect and disease problems, as well as nutrient deficiencies, in an efficient and environmentally friendly way. Also, some trees are too large to spray, in areas too close to houses, parks, water courses, or other environmentally sensitive areas where spraying is not a viable option, or the root system may be inaccessible for soil systemic treatments, making trunk injection the best or only option available in such cases.

The term “effective amount” as used herein refers to that amount of a substance that is necessary to produce a desired effect. In some embodiments, an effective amount of jasmonate inhibitor is that amount of jasmonate inhibitor that delays flowering by at least 1 day when administered in a suitable manner to a tree (e.g., appropriate formulation of jasmonate inhibitor applied at an appropriate time given the stage of bud development).

### Jasmonate Inhibitors

In some embodiments, the jasmonate inhibitor comprises diethyldithiocarbamate (DIECA) or salt thereof. Diethyldithiocarbamate is a member of the class of dithiocarbamate anions resulting from the removal of the proton from the dithiocarbamic acid moiety of diethyldithiocarbamic acid. It is a conjugate base of a diethyldithiocarbamic acid.

Diethyldithiocarbamate salts and derivatives which can also be used include zinc dimethyldithiocarbamate (ZMD), sodium dimethyldithiocarbamate (SMD), bismuth dimethyldithiocarbamate (BMD), calcium dimethyldithiocarbamate (CAMD), copper dimethyldithiocarbamate (CMD), lead dimethyldithiocarbamate (LMD), selenium dimethyldithiocarbamate (SEMD), sodium diethyldithiocarbamate (SDC), ammonium diethyldithiocarbamate (ADC), copper diethyldithiocarbamate (CDC), lead diethyldithiocarbamate (LDC), selenium diethyldithiocarbamate (SEDC), tellurium diethyldithiocarbamate (TEDC), zinc dibutyldithiocarbamate (MUD), sodium dibutyldithiocarbamate (SBUD), dibutyl ammonium dibutyldithiocarbamate (DBUD), zinc dibenzyldithiocarbamate (ZBD), zinc methylphenyl dithiocarbamate (ZMPD), zinc ethylphenyl dithiocarbamate (ZEPD), zinc pentamethylene dithiocarbamate (ZPD), calcium pentamethylene dithiocarbamate (CDPD), lead pentamethylene dithiocarbamate (LPD), sodium pentamethylene dithiocarbamate (SP)), piperidine pentamethylene dithiocarbamate (PPD), and zinc lopetidene dithiocarbamate (ZLD).

Other thiazole derivatives which can be used include 2-mercaptobenzothiazole (MBT), copper dimercaptobenzothiazole (CMBT), benzthiazyl disulphide (MBTS), and 2-(2′,4′-dinitrophenylthio) benzthiazole (DMBT).

Other guanidine derivatives which can be used include diphenyl guanidine acetate (DPGA), diphenyl guanidine oxalate (DPGO), diphenyl guanidine phthalate (DPGP), di-o-tolyl guanidine (DOTG), phenyl-o-tolyl guanidine (POTG), and triphenyl guanidine (TPG)

In some embodiments, the jasmonate inhibitor comprises JM-8686 or salt thereof, having the formula (I):

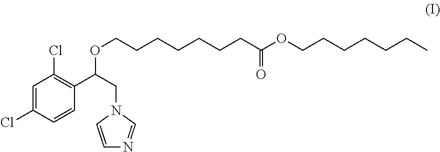 [SMILES: CCCCCCCOC(=O)CCCCCCCOC(Cn1ccnc1)c1ccc(Cl)cc1Cl]

JM-8686, 8-[1-(2,4-dichloro-phenyl)-2-imidazol-1-yl-ethoxy]-octanoic acid heptyl ester can be synthesized and purified according to the method described in Oh, et al. Bioorg. Med. Chem., 2002 10:3707-3711, which is incorporated by reference in its entirety for the teaching of this compound and other inhibitors thereof as well as the synthesis thereof.

In some embodiments, the jasmonate inhibitor comprises neomycin. Neomycin has been shown to act as an inhibitor of JA-mediated reactions in several different plant species (Vadassery, J., et al. J Plant Growth Reg. 2019 38(2):713-722)

In some embodiments, the jasmonate inhibitor comprises an octadecanoid pathway inhibitor. For example, in some embodiments, the jasmonate inhibitor comprises n-propyl gallate, acetylsalicylic acid, salicylhydroxamic acid, or methyl salicylate and antipyrine.

Jasmonate inhibitors are described in WO2015040061A1, which is incorporated by reference in its entirety for the teaching of these compounds and synthesis thereof. These inhibitors are jasmonate analogs that compete with endogenous jasmonate for receptor binding.

### Fruit Trees

The disclosed compositions and methods can be used to delaying flowering of fruit trees. In some embodiments, the fruit tree is a perennial fruit tree. In some embodiments, the perennial fruit tree is selected from the group consisting of apple, apricot, avocado, citrus (e.g., orange, lemon, grapefruit, tangerine, lime and citron), peach, pear, pecan, pistachio, and plum. In some embodiments, the fruit tree is a stone fruit tree (e.g. apricot, nectarines, peach, plum).

### Compositions

The jasmonate inhibitors disclosed herein may be formulated with one or more of a pH stabilizer, an anti-oxidant (or other compound for increasing shelf life), a bioactive agent (e.g., insecticide, fungicide, bactericide, and/or acaricide), and other materials to improve chemical adsorption, uptake, and translocation inside plant tissues. In addition, the jasmonate inhibitors can be formulated in a mixture with a carrier or, if necessary, other auxiliary agents to form any one of the standard types of preparations commonly used in agriculture, for example, a dry blend, granules, a wettable powder, an emulsion, an aqueous solution and the like.

Suitable solid carriers are clay, talc, kaolin, bentonite, terra abla, calcium carbonate, diatomaceous earth, silica, synthetic calcium silicate, kieselguhr, dolomite, powdered magnesia, Fuller's earth, gypsum and the like. Solid compositions can also be in the form of dispersible powders or grains, comprising a surfactant to facilitate the dispersion of the powder or grains in liquid.

Liquid compositions include solutions, dispersions or emulsions containing the natural metabolite (adenosine and the like) together with one or more surface-active agents (surfactants) such as wetting agents, dispersing agents, emulsifying agents, or suspending agents. In those applications in which the compounds are applied as a foliar spray, surfactants are preferably used. Surfactants reduce the surface tension in the spray droplet to ensure that the material applied spreads out and covers the leaf surface rather than beading up. This facilitates absorption of the applied material into the plant. Surfactants can also affect the uptake of materials directly by changing the viscosity and crystalline structure of the waxes on the surface of the leaf or other tissues (Tu and Randall, Chapter 8-Adjuvants. In: Tu et al., [Eds.] Weed Control Methods Handbook: Tools and Techniques For Use In Natural Areas. The Nature Conservancy p. 219, 2001).

Generally, any number of surfactants may be used consistent with the purpose of this constituent. For example, the surfactant can comprise a nonionic, anionic, cationic, or zwitterionic surfactant. The surfactant can be present in the composition of the disclosure as formulated or, alternatively, the surfactants can be introduced during administration to the plant. In such an instance, regardless of whether the administration is conducted via automated or manual means, the surfactant can be combined with the composition of the disclosure prior to, or co-dispensed separately. Cationic surfactants useful in compositions of the disclosure include but are not limited to amine ethoxylates, amine oxides, mono- and dialkylamines, imidazolinium derivatives, and alkylbenzyldimethylammonium halides. Nonionic surfactants useful in the context of this disclosure are generally polyether (also known as polyalkylene oxide, polyoxyalkylene or polyalkylene glycol) compounds. More particularly, the polyether compounds are generally polyoxypropylene or polyoxyethylene glycol compounds. Anionic surfactants useful with the disclosure comprise, for example, alkyl carboxylates, linear alkylbenzene sulfonates, paraffin sulfonates and secondary n-alkane sulfonates, sulfosuccinate esters and sulfated linear alcohols. Zwitterionic or amphoteric surfactants useful with the disclosure include but are not limited to alpha-N-alkylaminopropionic acids, n-alkyl-alpha-iminodipropionic acids, imidazoline carboxylates, amine oxides, sulfobetaines and sultaines.

Although the surfactant can be present in the composition in any useful amount, in preferred embodiments, it is present in an amount from about 0.01% to about 25%, more preferably from about 0.01% to about 10% and more preferably still from about 0.05% to about 5%. A surfactant is present in the compositions of the disclosure in a useful amount when it facilitates the dissolution of the natural metabolite, enhances its uptake by the plant, and/or its effectiveness in inducing the desired response. In a preferred embodiment, the surfactant is a polysorbate, which is present in an amount from about 0.05% to about 5%. In a particularly preferred embodiment, the surfactant is polysorbate 20 (polyoxyethylene 20 sorbitan monolaurate), which is present in the composition in an amount from about 0.05% to about 5%.

The compositions of the disclosure can also contain suspending agents. Suitable suspending agents are, for example, hydrophilic colloids, for example polyvinylpyrollidone and sodium carboxymethylcellulose, and the vegetable gums, for example, gum acacia and gum tragacanth.

Aqueous solutions, dispersions or emulsions may be prepared by dissolving the natural metabolite (adenosine or the like) in water or an organic solvent which can, if desired, contain one or more surface active, sticking, wetting, dispersing, or emulsifying agents. Suitable organic solvents are, for example, alcohols, hydrocarbons, oils and sulfoxides. In embodiments using alcohols, methanol, isopropyl alcohol, propylene glycol and diacetone alcohol are preferred. In embodiments using oils, petroleum oils are preferred. Of the sulfoxides, dimethylsulfoxide is preferred.

The compositions which are to be used in the form of aqueous solutions, dispersions or emulsions are generally supplied in the form of a concentrate containing a high proportion of the natural metabolite (adenosine or the like), and the concentrate is then diluted with water before use. These concentrates are usually required to withstand storage for prolonged periods and after such storage, to be capable of dilution with water in order to form aqueous preparations that remain homogeneous for a sufficient time to enable them to be applied by conventional spray equipment. In general, concentrates can conveniently contain from 10 to 60 percent by weight of the natural metabolite (adenosine or the like).

Exemplary bioactive compounds with which compositions of the present disclosure can be formulated include but are not limited to: insecticides such as abamectin, acephate, acetamiprid, avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, picoxystrobin, pirimicarb, profenofos, pymetrozine, pyridalyl. pyriproxyfen, rotenone, spinosad, sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron; fungicides such as acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(pheny-lamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), myclobutanil, neo-asozin (ferric methanearsonate), oxadixyl, penconazole, pencycuron, probenazole, prochloraz, propamocarb, propiconazole, pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin; nematocides such as aldicarb, oxamyl and fenamiphos; bactericides such as streptomycin; and acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad. A general reference for these agricultural protectants is The Pesticide Manual, 12th Edition, Tomlin, Ed., British Crop Protection Council, Farnham, Surrey, United Kingdom, 2000.

A number of embodiments of the invention have been described. Nevertheless, it will be understood that various modifications may be made without departing from the spirit and scope of the invention. Accordingly, other embodiments are within the scope of the following claims.

### EXAMPLES

### Example 1

### Introduction

Previous studies have demonstrated that ethephon (2-chloroethylphosphonic acid, ET), an ethylene-releasing PGR can delay bloom in peach and other stone fruits when applied in the fall (Liu, J., et al. Front Plant Sci. 2019 10:1408; Liu, J., et al. Plants, 2021 10(7):1266). At high concentration, ET can induce bloom delay by more than two weeks, which would significantly reduce the risk of frost damage. However, such application often leads to detrimental effects, such as gummosis, abortion of floral buds and dieback of the branches, and have limited the utility of ET in frost protection (Liu, J., et al. Front Plant Sci. 2019 10:1408). Recent studies indicated that ET extends the duration of bud dormancy in peach (Liu, J., et al. Plants, 2021 10(7):1266). The hormonal analysis of ET-treated and untreated peach floral buds at regular intervals of CHs and GDHs showed a key role for jasmonic acid (JA) in mediating budburst and bloom in peach, which also appears to be influenced by ethephon treatment. The level of JA and its bioactive form JA-isoleucine (JA-Ile) dramatically elevated in peach floral buds at 3000 GDH, just several days before budburst. However, it was noticeable that JA and JA-Ile levels were lower in the ethephon treatment than control (Liu, J., et al. Plants, 2021 10(7):1266).

JA has long been known for its role to break seed dormancy, as exogenous JA can substitute for cold stratification and stimulate seed germination (Berestetzky, V., et al. Biochemie und Physiologie der Pflanzen. 1991 187(1):13-19). Recent studies indicated that JA is also involved in the release of bud dormancy. For example, Juvany, M., et al. Trees, 2015 29(6):1781-1790 demonstrated that JA levels in beech (Fagus sylvatica) buds increase during transition from dormancy to budbreak and in a transcriptome study on tea (Camellia sinensis), Hao, X., et al. Front Plant Sci. 2017 8:553 showed that the genes associated with JA synthesis are downregulated during dormancy but upregulated upon budbreak. Along the same vein, JA biosynthesis genes were found to be upregulated by hydrogen cyanamide (HC), a widely used budbreak inducer (Ionescu, I. A., et al. Front Plant Sci. 2017 8:1233). Lin, S. Y., et al. Plant Growth Regulation, 2021 94(2):171-181 also observed an increase in JA levels in response to HC in blueberry (Vaccinium corymbosum), with a concomitant decrease of abscisic acid (ABA), a key plant hormone controlling bud dormancy. In tomato, the levels of newly synthesized JA peaked two days before flowering, and flower opening was delayed in jai1.1, a tomato JA-insensitive mutant (Niwa, T., et al. Biosci Biotechnol Biochem. 2018 82(2):292-303). Though the exact role or JA in dormancy release is yet to be elucidated, these findings pointed to the involvement of JA in the regulation of budbreak and flowering. It is therefore hypothesized that inhibition of JA may hinder the process of dormancy release and potentially delay the bloom date in peach.

JA belongs to jasmonates, a class of lipid-based plant hormones that regulate diverse processes in plants development and stress responses (Browse, J. (2009). Phytochemistry. 70(13-14):1539-1546). Bioactive forms of JA include, but are not limited to jasmonic acid (JA), methyl jasmonate (MeJA), JA-Ile and 12-oxophytodienoic acid (OPDA). JA levels in plants can exogenously be modulated by sodium diethyldithiocarbamate (DIECA), a potential JA biosynthetic inhibitor. DIECA can interrupt the JA biosynthesis pathway by shutting the conversion of 13(S)-hydroperoxylinolenic acid to 13-hydroxylinolenic acid, a key JA biosynthetic precursor (Farmer et al., 1994). Application of DIECA has been shown to substantially reduce JA levels in several plant species such as ginseng (Hu, F. X., et al. Process Biochemistry, 2008 43(1):113-118), wheat (Xiang, Y., et al. J Exp Bot. 2011 62(15):5471-5483) and tea plant (Camellia sinensis) (Zhang, J., et al. J Chem Ecol. 2020 46(3):308-316). Up to date, no published study has been reported on the use of JA inhibitors to modulate bud dormancy or flowering in fruit trees. In this study, the effects DIECA in delaying bloom time in peach was tested using different application regimes during the ecodormancy period.

### Materials and Methods

### Location and Plant Materials

The field trials were taken place at the Alson H. Smith Jr. Agricultural Research and Extension Center (AREC), Winchester, VA, the United States (39°06′36.0′N 78°16′48.0′W). Experiments were conducted over two growing seasons (2021 and 2022) on 3-year-old ‘John Boy’ and 10-year-old ‘Redhaven’ peach trees; both are grafted on ‘Lovell’ rootstock.

### Chilling and Heat Requirements

Chilling and heat accumulation were computed from meteorological data obtained from each orchard. Data loggers (EasyLog, Lascar) were kept in enclosed wooden shelters 1.2 m above the ground and recorded temperatures at 10 min intervals. Chilling requirements were calculated using the chilling hours (CH) model (Weinberger, 1950), in which each hourly temperatures within the range of 0-7.2° C. were registered as 1 CH, and temperatures outside of this range were not considered. Starting at 500 CH, three one-year-old branches, each with at least 10 floral buds, were collected weekly from each treatment. After removal of the terminal buds, the branches were placed in a beaker containing a floral solution prepared with Floralife (Smithers-Oasis Co., Walterboro, SC, USA). The floral solution was replaced weekly and around 1 cm was trimmed from the basal end of each branch to eliminate potential infections. The branches were kept in a growth chamber with conditions favoring bud growth (photoperiod with fluorescent lamps at 135 μmol·m⁻²·s⁻¹ of 16 h at 25° C., a dark period of 8 h at 20° C., and a constant relative humidity of 65%). The endodormancy release and CRs were considered fulfilled when 50% of the buds have reached the calyx green stage after 14 days in the growth chamber.

After completion of CR, heat requirements were recorded according to the growing degree hours (GDH) model proposed by Richardson et al. (1975). In this model, hourly temperatures less than 4.5° C. registered no GDH; temperatures in the interval of 4.5-25° C. were adjusted by subtracting 4.5° C., and temperatures greater than 25° C. were registered as 20.5 (25-4.5) GDH. Heat requirements (HR) were calculated as the GDH accumulated from the date of endodormancy release (under growth chambers conditions) to the date 50% of buds were in full bloom, F50 (under field conditions).

### Experiment 1 (2021)

This trial was conducted on ‘John Boy’ peach trees. Three different concentrations (0.5 mM, 10 mM, and 25 mM) of DIECA (Sigma-Aldrich Co., St Louis, MO, USA) were sprayed on three groups of trees, each group is composed of three adjacent trees. Treatments and control (untreated) trees were arranged in a completely randomized design (CRD). At least one buffer tree was assigned between each treatment to avoid spray drift. Trees were sprayed on 3 Mar. 2021 at 1000 GDH at a spray volume of 0.3 L per tree, using a hand sprayer. Regulaid (250 ppm), a non-ionic surfactant from Kalo Inc. (Overland Park, KS, United States) was mixed with all treatments and experiments at the rate of 250 ppm.

### Experiment 2 (2021)

The ‘Redhaven’ peach orchard was used to examine the effect of DIECA application timing on flowering time. Four randomly selected tree groups, each with three adjacent trees were used to examine three application timings (1000 GDH, 2000 GDH and 1000+2000 GDH) of DIECA (10 mM) and untreated control. DIECA treatments were made on 8 March, 15 March and 9+16 March, respectively. Each tree was sprayed with 1.8 L of DIECA solution using a high-pressure tree sprayer.

### Experiment 3 (2022)

In this trial, we used peach ‘Redhaven’ trees to examine the effects of three different concentrations (12.5, 25 and 50 mM) of DIECA on blooming time. Three adjacent trees were assigned for each treatment. All treated and untreated (control) trees were distributed in the orchard according to the CRD experimental design. DIECA treatments were applied at 500 GDH at a spray volume of 1.8 L per tree, using a high-pressure tree sprayer.

### Experiment 4 (2022)

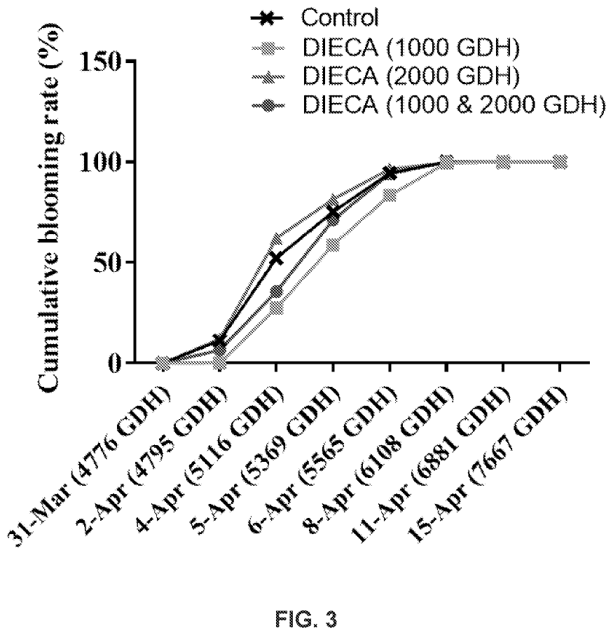

The purpose of this trial was to examine the effects of applying DIECA at a later timing of the dormancy period (2000 GDH) on the bloom date of ‘John Boy’ peach trees. A CRD was used to accommodate a DIECA treatment (50 mM) and control, each with three adjacent trees (FIG. 3), and a minimum of two buffer trees between treatment trees. The untreated control group was sprayed with water containing surfactant only. The treatment group was exogenously sprayed with DIECA on 3 March using a high-pressure tree sprayer.

### Experiment 5 (2023)

In this study, we investigated the influence of propyl gallate and Antipyrine on the flowering time of ‘Redhaven’ and ‘Sunhigh’ cultivars. Three adjacent trees were randomly chosen, each as a replicate, and subjected to treatments: propyl gallate (15 mM), antipyrine (50 mM), and an untreated control. Four applications of each treatment were administered weekly, commencing at the swollen bud stage, which are concurrent at 2059, 2167, 2356, and 3128 DGH, respectively, employing a hand sprayer with the volume of 2.5 L per tree. Regulaid, a non-ionic surfactant from Kalo Inc. (Overland Park, KS, United States) was mixed with all treatments and experiments at the rate of 250 ppm.

### Evaluation of Bloom Progression and Fruit Set

At the pink-bud stage, three-four branches from each treated and untreated (control) tree were randomly selected across the tree and flagged using colored ribbons. The number of buds on selected branches (at least 80 bud/tree) was used as the initial bud count. The progression of flower opening was recorded by periodically counting the number of open blossoms in each experiment. The number of open flowers (anthers visible) was counted every 1-3 days until all buds reached the full bloom stage (50% of flowers are fully open). The blooming rate at each time point was calculated as the ratio of open blossoms to the initial bud number per tree, and the flowering date (F50) for each treatment was determined when the blooming rate reached 50%. The numbers of fruit on the marked branches were counted 2 and 4 and 8 weeks after full bloom. Percent fruit set was calculated as the number of fruits divided by the number of flowers times 100.

### Results

### Exp. 1. Effects of Different Concentrations of DIECA Application on Blooming of ‘John Boy’ Peach

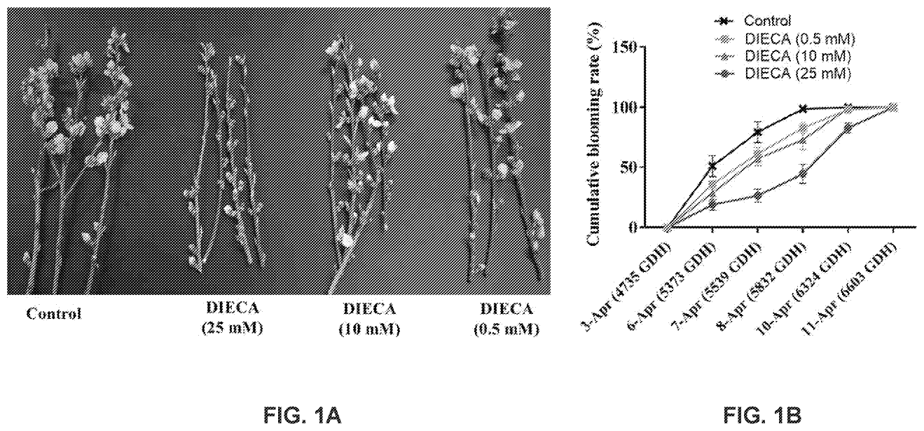

In the trial of 2021, three different concentrations (0.5, 10, and 25 mM) of DIECA were exogenously applied to the ‘John Boy’ peach at 1000 GDH. The highest concentration of DIECA (25 mM) treatment showed significant delay in the blooming (Table 1; FIG. 1). The flowering date (F50) of the control occurred on 6 April (Table 1), whereas the DIECA (100 mM) treatment resulted in three days delay of the flowering date (Table 1; FIGS. 1A, 1B).

TABLE 1
Effects of different concentrations of diethyldithiocarbamate
(DIECA) on heat requirements and flowering date of
‘John Boy’ peach (2021).

| Treatment | Heat requirements ^{x} | Flowering (F50) ^{y} | Days ^{z} |
|---|---|---|---|
| Control | 5373 | 06 April | 69 b |
| DIECA (0.5 mM) | 5373 | 06 April | 69 b |
| DIECA (10 mM) | 5539 | 07 April | 70 b |
| DIECA (25 mM) | 6048 | 08 April | 72 a |

^{x} Heat requirements (HR) is displayed as the number of growing degree hours (GDH).
^{y} Date at which 50% of buds were at the open-blossom stage (F50).
^{z} Number of days from endodormancy release to flowering (F50). Means sharing the same letter are not significantly different at α = 0.05, using Tukey's HSD test.

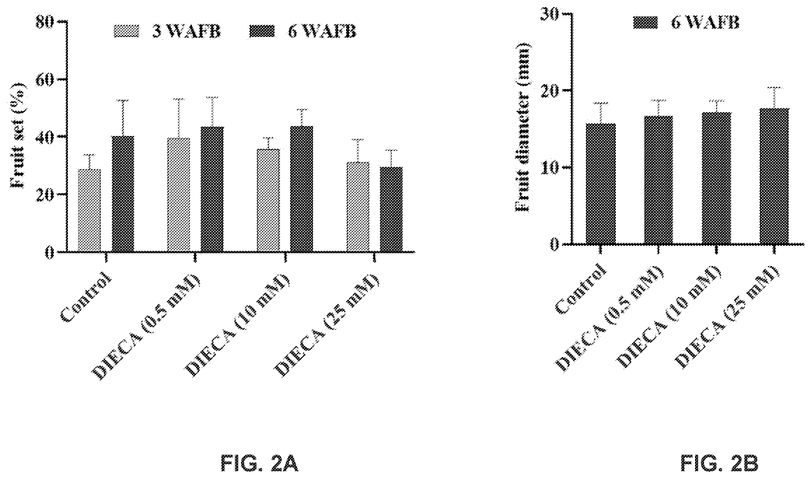

DIECA's effects on fruit set (%) were evaluated at 3 and 6 weeks after full bloom (WAFB) (FIG. 2A), and the effects on fruit size were assessed at 6 WAFB (FIG. 2B). No significant differences in fruit set and fruit size were observed between the control and DIECA treatments at any time point.

### Exp. 2. Effects of Different Timing Application of DIECA on Blooming of ‘Redhaven’ Peach

Another trial was conducted in 2021 with ‘Redhaven’ peaches, in which the effects of application timing of DIECA on blooming time were evaluated. DIECA (10 mM) was applied either once (at 1000 or 2000 GDH) or twice (at 1000 and 2000 GDH). None of the DIECA application timings showed a significant bloom-delaying effect. However, the trees treated at 1000 GDH showed slightly delayed bloom progression compared to the control, suggesting that early applications of DIECA are more effective in delaying bloom progression.

### Exp. 3. Effects of Different DIECA Concentrations on the Bloom Time of ‘Redhaven’ Peach

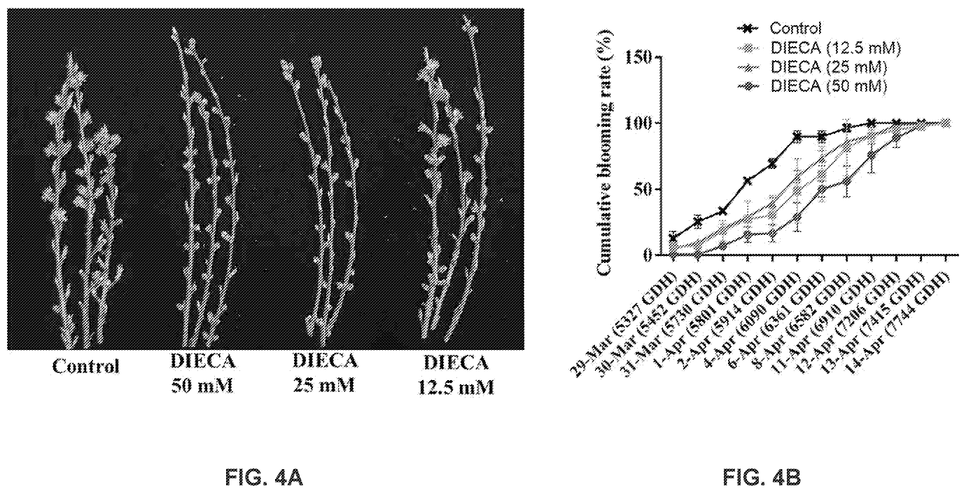

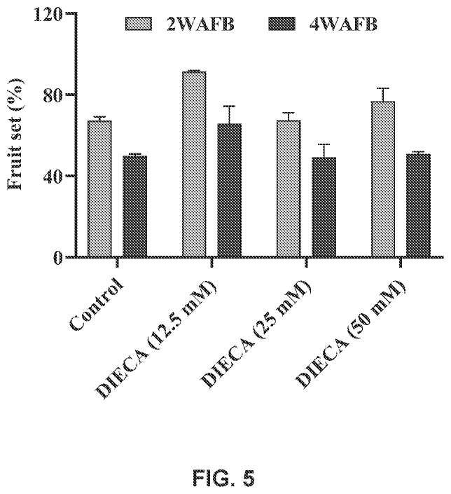

In this experiment, we examined three DIECA concentrations (12.5, 25, and 50 mM) on ‘Redhaven’ peach trees at 500 GDH. As shown in FIG. 4, all DIECA applications induced remarkable bloom delay, with concentrations of 25 and 50 mM showing significant delays in bloom date compared to the control. These concentrations resulted in 3- and 6-days delay in bloom time, respectively, compared to the untreated control (Table 2). This experiment indicated that high DIECA concentrations (more than 25 mM) and early applications (around 500 GDH) are highly effective in delaying bloom in peach. Fruit set (%) evaluated at 2 and 4 WAFB did not show significant differences between the control and DIECA treatments at any time point (FIG. 5).

TABLE 2
Effects of different concentrations of diethyldithiocarbamate
(DIECA) on heat requirements and flowering date of
‘Redhaven’ peach (2022).

| Treatment | Heat requirements ^{x} | Flowering (F50) ^{y} | Days ^{z} |
|---|---|---|---|
| Control | 5801 | 01 April | 72 c |
| DIECA (12.5 mM) | 6090 | 04 April | 75 bc |
| DIECA (25 mM) | 6090 | 04 April | 75 b |
| DIECA (50 mM) | 6478 | 07 April | 78 a |

^{x} Heat requirements (HR) is displayed as the number of growing degree hours (GDH).
^{y} Date at which 50% of buds were at the open-blossom stage (F50).
^{z} Number of days from endodormancy release to flowering (F50). Means sharing the same letter are not significantly different at α = 0.05, using Tukey's HSD test.

### Exp. 4. Effects of Late DIECA Applications on Bloom Time of ‘John Boy’ Peach

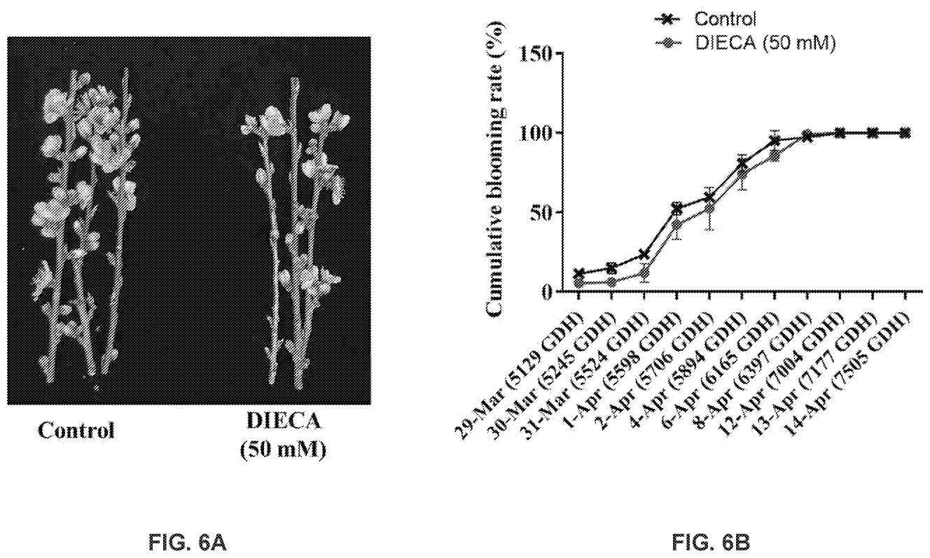

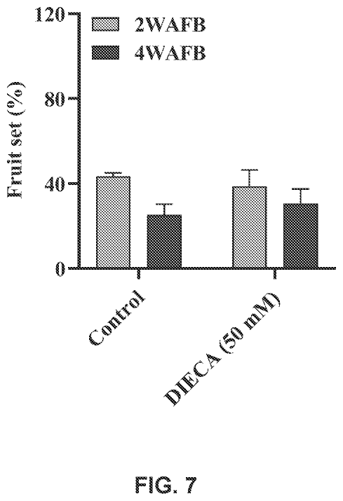

In a 2022 experiment, we sprayed ‘John Boy’ peach trees with DIECA (50 mM) at 2000 GDH and observed the effects on bloom time and fruit set. No significant differences in the flowering time were observed between the control and the DIECA treatment (FIG. 6a, b). Similarly, no significant differences in fruit set (%) were found between DIECA and control trees, verifying our previous notion that later DIECA applications (after 500 GDH) have no effect on bloom time (FIG. 7).

### Exp. 5. Effects of Propyl Gallate and Antipyrine Applications on Booming Time of ‘Redhaven’ and ‘Sunhigh’ Peach

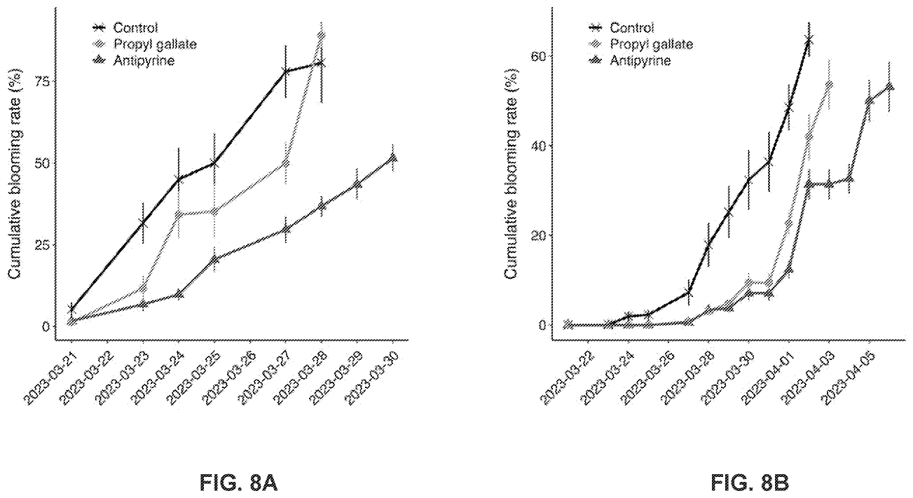

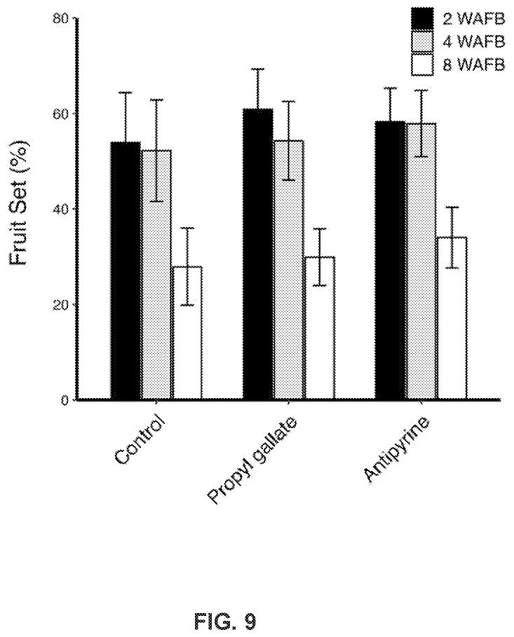

In 2023, four weekly applications of propyl gallate (15 mM) and antipyrine (50 mM) were applied to ‘Redhaven’ and ‘Sunhigh’ cultivars, commencing at the swollen bud stage (at 2059, 2167, 2356, and 3128 DGH, respectively). Flowering progression was observed at a daily basis. Antipyrine treatments significantly delayed bloom in both ‘Sunhigh’ (by four days) and ‘Redhaven’ (by two days). However, propyl gallate exhibited a single-day bloom delay only in ‘Sunhigh’, with no significant impact on ‘Redhaven’ compared to the control (FIG. 8a, b). Fruit set data were collected at 4, 6, and 8 weeks after full bloom, showing no significant differences in percent fruit set for ‘Redhaven’ (FIG. 9) between treatments and the control. Likewise, fruit quality attributes displayed no significant distinctions between treatments and control. Due to the devastating 2023 frost event, no fruits were retained on ‘Sunhigh’ for further examination.

### DISCUSSION

Previous investigations indicated that ethephon-mediated bloom delay in peach was associated with a decline in JA levels and downregulation of JA biosynthetic genes by the time of budburst. Therefore, in this study, the effects of DIECA, a JA biosynthetic inhibitor, was examined on the bloom time of two peach cultivars, ‘John Boy’ and ‘Redhaven’. Data showed that high DIECA concentrations (>25 mM) applied at the early stage of ecodormancy (˜500 GDH) can significantly delay bloom in peach by 3-6 days, which could serve as an effective frost avoidance strategy in peach and other deciduous fruit species. Other modes of actions by which DIECA could interfere with the flowering time include the effect of DIECA on reactive oxygen species (ROS) hemostasis by inhibiting the superoxide dismutase (SOD) enzyme. SOD catalyzes the partitioning of superoxide (O₂⁻) into oxygen and hydrogen peroxide (H₂O₂). H₂O₂ induction in floral buds is a characteristic signal of endodormancy release in peach, apple, walnut and grapes (Gholizadeh, J., et al. Scientia Horticulturae. 2017 225:29-37; Pérez, F. J., et al. J Plant Physiol. 2005 162(3):301-308; Sapkota, S., et al. Antioxidants, 2021 10(10):1549), and therefore the inhibition of SOD by DIECA could delay bloom via reducing H₂O₂ levels. DIECA was also found to induce the expression of matrix metalloproteinase-1 (MMP1) gene in hepatic stellate cells (Liu, T., et al. Bioscience Reports, 2016 36(4)). In rice, the overexpression of OsMMP1 gene led to enhanced deposition of cellulose and callose, and subsequently the inhibition of symplastic and apoplastic translocations (Das, P. K., et al. Scientific reports. 2018 8(1):1-16). Callose deposition is of particular importance with respect to bud dormancy as it reduces the movement of mobile molecules, e.g., flowering locus T, auxins and sugars, essential for growth resumption, morphogenesis and budburst (Liu, J., et al. Front Plant Sci. 2019 10:1408). Therefore, it was not surprising that transcriptomic analysis of peach floral buds during dormancy showed a decline in the expression of callose synthase (1,3-β-glucansynthase) and induction in glucan hydrolase (1,3-β-glucanase) genes after the endodormancy release (Liu, J., et al. Int J Mol Sci. 2022 23(12):6801).

There are several salt forms of DIECA including potassium-DIECA, that is used as a biocide for paper mills, sugar mills and water treatments; sodium-DIECA, that is commercially used in the precipitation of metals in wastewater treatments, and as a disinfectant, a chelating agent and coagulant; silver-DIECA, that is commonly used for detection of arsenic in water and sewage; zinc-DIECA, that is used as a fungicide under the tradename Ziram; and copper-DIECA, that is used as a drug for the treatment of alcoholism, and as a potential anti-cancer drug. In the present research, bloom delay effect for the Na-DIECA only was demonstrated. However, other forms of DIECA could also induce bloom delay. Other chemical inhibitors of JA are also expected to show a bloom delay effect similar, or even better than DIECA. These chemicals include, JM-8686, a competitive inhibitor of allene oxide synthase (AOS) (Oh, K., et al. FEBS letters, 2006 580(24):5791-5796); neomycin, an inhibitor of JA-induced reactions (Vadassery, J., et al. J Plant Growth Reg. 2019 38(2):713-722); and octadecanoid pathway inhibitors (n-propyl gallate, acetylsalicylic acid, salicylhydroxamic acid, methyl salicylate and antipyrine) (Baldwin, I. T., et al. J Chem Ecol. 1996 22(1):61-74). Inhibition of JA biosynthesis using exogenous double-strand RNA (dsRNA) or short-interference RNA (siRNA) is also expected to cause bloom delay similar to that of DIECA.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1. A method for delaying flowering of deciduous fruit trees, comprising applying to the tree an effective amount of a jasmonate inhibitor, wherein the jasmonate inhibitor comprises diethyldithiocarbamate (DIECA) or salt thereof.

2. The method of claim 1, wherein the jasmonate inhibitor comprises diethyldithiocarbamate (DIECA) or salt thereof.

3. The method of claim 2, wherein the jasmonate inhibitor comprises potassium-DIECA, sodium-DIECA, silver-DIECA, zinc-DIECA, or copper-DIECA.

4. The method of claim 1, wherein the jasmonate inhibitor comprises JM-8686 or salt thereof.

5. The method of claim 1, wherein the jasmonate inhibitor comprises neomycin.

6. The method of claim 1, wherein the jasmonate inhibitor comprises an octadecanoid pathway inhibitor.

7. The method of claim 6, wherein the jasmonate inhibitor comprises n-propyl gallate, acetylsalicylic acid, or salicylhydroxamic acid.

8. The method of claim 1, wherein the deciduous fruit tree is an apple, European pear, Asian peach, quince, peach, nectarine, apricot, sour cherry, sweet cherry, plum, pecan, walnut, almond, pistachio, hazel or filbert tree.

9. The method of claim 1, wherein the jasmonate inhibitor is administered at a concentration of 1 mM to 1000 mM.

10. The method of claim 1, wherein the jasmonate inhibitor is applied at 100 to 3000 growing degree hours (GDH).

11. The method of claim 1, wherein the jasmonate inhibitor is applied to the tree prior to freezing conditions to delay flowering and prevent frost damage.

12. The method of claim 11, wherein flowering is delayed 7 to 14 days.

13. The method of claim 1, wherein the jasmonate inhibitor is applied to the tree when the temperature is below 32° F. or is forecast to drop below 32° F.
